(19) United States
(12) Patent Application Publication
(10) Pub. No.: US 2014/0008100 A1
(43) Pub. Date: Jan. 9, 2014

(54) Alternative Current (AC) Power Line

(71) Applicant: Li-Chun LAI, New Taipei City (TW)

(72) Inventor: Li-Chun LAI, New Taipei City (TW)

(21) Appl. No.: 13/543,809

(22) Filed: Jul. 7, 2012

(51) Int. Cl. H01B 9/00

(52) U.S. Cl. 174/113 R

(57) ABSTRACT

An alternative current (AC) power line, comprising: at least two conductive lines having an insulation sheath, and an insulation protective outer layer wrapping the aforementioned at least two conductive lines. The insulation protective outer layer includes: an insulation cladding layer and a spiral enhancing layer. The spiral enhancing layer is attached to the outer surface of the insulation cladding layer in a spiral way along the axial direction of the AC power line. Also, the spiral enhancing layer is jointed in a spiral pattern and protrudes from the outer surface of the insulation cladding layer. The spiral enhancing layer may be of a uni-spiral or multi-spiral structure. In another embodiment, the spiral enhancing layer is of a multi-spiral structure in an alterative thick-thin fashion which improves the anti-tension and anti-extension capabilities in the AC power line and facilitates visual differentiation or identification effects.

### BACKGROUND OF THE INVENTION

1. Field of the Invention

The present invention generally relates to the structure of a power line; in particular, it relates to the structure of an alternative current (AC) power line.

2. Description of Related Art

The electric power supply system is an extremely important infrastructure in modern human societies, and alternative current (AC) power lines are the major media for electric power transmissions in the power supply system. For a common main power supply system, in order to protect the electric power facilities and application safety, relevant laws, regulations, and security directives are stipulated in every countries all over the world.

In a general AC power line, the exteriors of metal conductive lines are wrapped with insulation sheaths so as to prevent dangers due to exposure of metal conductive lines for electric power transmissions. The main purpose of the insulation sheath wrapping the AC power line is to provide the electric insulation function, which is commonly fabricated with PVC plastic materials. Moreover, based on the type, specification and usage of the AC power line, the insulation sheath on certain AC power lines is required to be resistive to physical or mechanical damages or to enable anti-corrosive features. In other word, it needs to demonstrate characteristics of anti-tension and anti-extension as well as corrosion durability.

The AC power line for typical domestic utilizations may comprise two or three metal conductive lines 11 wrapped with the insulation sheath 10 (as shown in FIG. 1), and based on the type, specification and usage, the applied metal conductive line 11 can be further categorized into the single-cored line and the stranded line (multiple-cored line) which are usually differentiated by different colors on the insulation sheath 10 in order to identify the function of the metal conductive line 11. For example, the grounding line among such three metal conductive lines is generally set to have a green or yellow insulation sheath. As for the grounded line (also referred as the “neutral line”) adopts an insulation sheath of white or gray color, while the insulation sheath of the live wire is usually in red color. For another sort of AC power line suitable for cable line applications (as shown in FIG. 2), it is common to further cover a protective outer layer 20 onto the exteriors of the insulation sheath 10 of the two or three metal conductive lines 11 wrapped with the insulation sheath 10. That is, such a protective outer layer 20 can wrap together the insulation sheaths 10 of the aforementioned two or three metal conductive lines 11 so as to protect the two or three metal conductive lines 11 included therein thereby enabling increased resistance to physical or mechanical damages or corrosion durability.

### SUMMARY OF THE INVENTION

In order to resolve issues concerning that the protective outer layer on prior art AC power lines is merely of a single-layered structure as well as a user may encounter difficulties in identifying or searching for such prior art AC power lines because the exterior colors thereof can be easily merged with environmental background, the present invention herein provides a structure for AC power lines which improves the anti-tension and anti-extension capabilities of the AC power line and facilitates visual differentiation or identification effects.

The structure in an embodiment of the AC power line according to the present invention comprises:
at least two conductive lines having an insulation sheath; and
an insulation protective outer layer wrapping the exteriors of the at least two conductive lines, wherein the insulation protective outer layer includes: an insulation cladding layer and a spiral enhancing layer, in which the spiral enhancing layer is attached to the outer surface of the insulation cladding layer in a spiral way along the axial direction of the AC power line. From the traverse cross-section direction of the AC power line, it can be observed that the spiral enhancing layer is jointed in a spiral pattern and protrudes from the outer surface of the insulation cladding layer. Moreover, the colors of the insulation cladding layer and the spiral enhancing layer can be differently configured thereby improving the anti-tension and anti-extension capabilities of the AC power line and facilitating visual differentiation or identification effects.

According to an embodiment of the present invention, the spiral enhancing layer can be of a uni-spiral structure or a multi-spiral structure (i.e., single or multiple spirals).

According to an embodiment of the present invention, the multiple spiral enhancing layers in the multi-spiral structure have a uniform thickness (that is, of the same thickness).

According to an embodiment of the present invention, the multiple spiral enhancing layers in the multi-spiral structure have different thicknesses.

In summary, the structure of the AC power line according to the present invention is characterized in that the insulation protective outer lay includes an insulation cladding layer and a spiral enhancing layer, and the anti-tension and anti-extension capabilities of the AC power line can be improved by means of the spiral structure of the spiral enhancing layer. In addition, the colors of the insulation protective layer and the spiral enhancing layer enable significant visual distinction from background thereby facilitating visual differentiation or identification effects.

The detailed structures for the embodiments as well as other effects of the present invention will be illustrated hereunder in conjunction with the appended drawings.

### BRIEF DESCRIPTION OF THE DRAWINGS

FIG. 1 shows a diagram for the structure of a conventional power line;

FIG. 2 shows a diagram for the structure of another conventional power line;

FIG. 3 shows the structure for an embodiment of the AC power line according to the present invention;

FIG. 4 shows a cross-section view for the structure shown in FIG. 3 at a V-V position;

FIG. 5 shows the structure for another embodiment of the AC power line according to the present invention, indicating a spiral enhancing layer of the multi-spiral structure; and

FIG. 6 shows the structure for another embodiment of the AC power line according to the present invention, indicating a spiral enhancing layer of the multi-spiral structure having a think-thin differentiation feature.

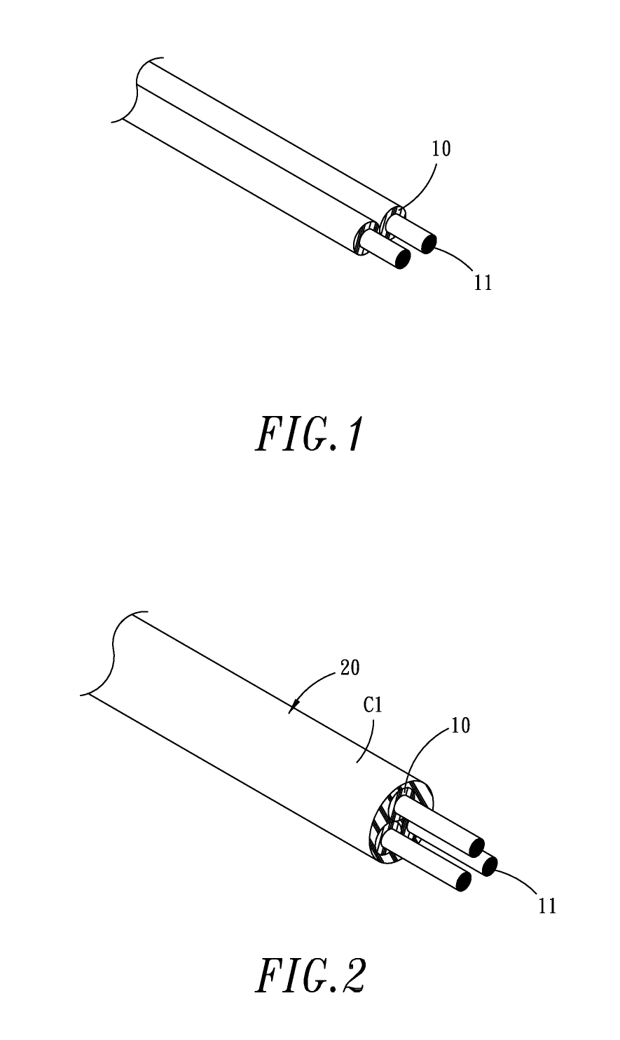

### DETAILED DESCRIPTION OF THE PREFERRED EMBODIMENTS

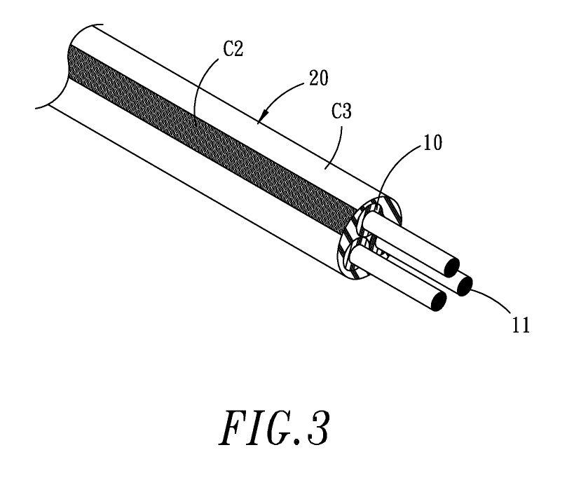

The structure for an embodiment of the AC power line according to the present invention is shown in FIG. 3, comprising:

at least two conductive lines 30a and 30b having an insulation sheath 31; and

an insulation protective outer layer, wrapping the exteriors of the aforementioned conductive lines 30a and 30b. Herein the insulation protective outer layer includes: an insulation cladding layer 40 and a spiral enhancing layer 50a, in which the spiral enhancing layer 50a is attached to the outer surface of the insulation cladding layer 40 in a spiral way along the axial direction of the AC power line. From the traverse cross-section direction of the AC power line, it can be observed that the spiral enhancing layer 50a is jointed in a spiral pattern and protrudes from the outer surface of the insulation cladding layer 40 (see FIG. 4). Moreover, the colors of the spiral enhancing layer 50a and the insulation cladding layer 40 are differently configured thereby improving the anti-tension and anti-extension capabilities of the AC power line and facilitating visual differentiation or identification effects.

According to an embodiment of the present invention, the insulation sheath 31, the insulation cladding layer 40 and the spiral enhancing layer 50a can be fabricated with polyvinyl chloride (PVC) materials. Through the plastic injection molding technology, the spiral enhancing layer 50a can be wrapped on the outer surface of the insulation cladding layer 40 by means of the extrusion cladding method and spin molds.

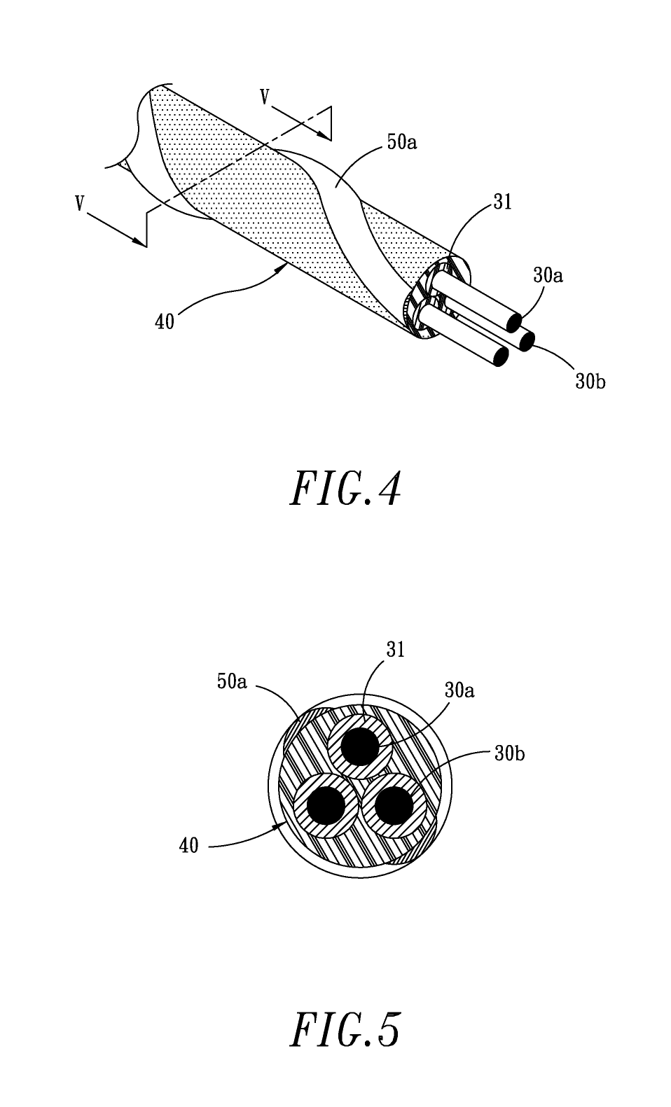

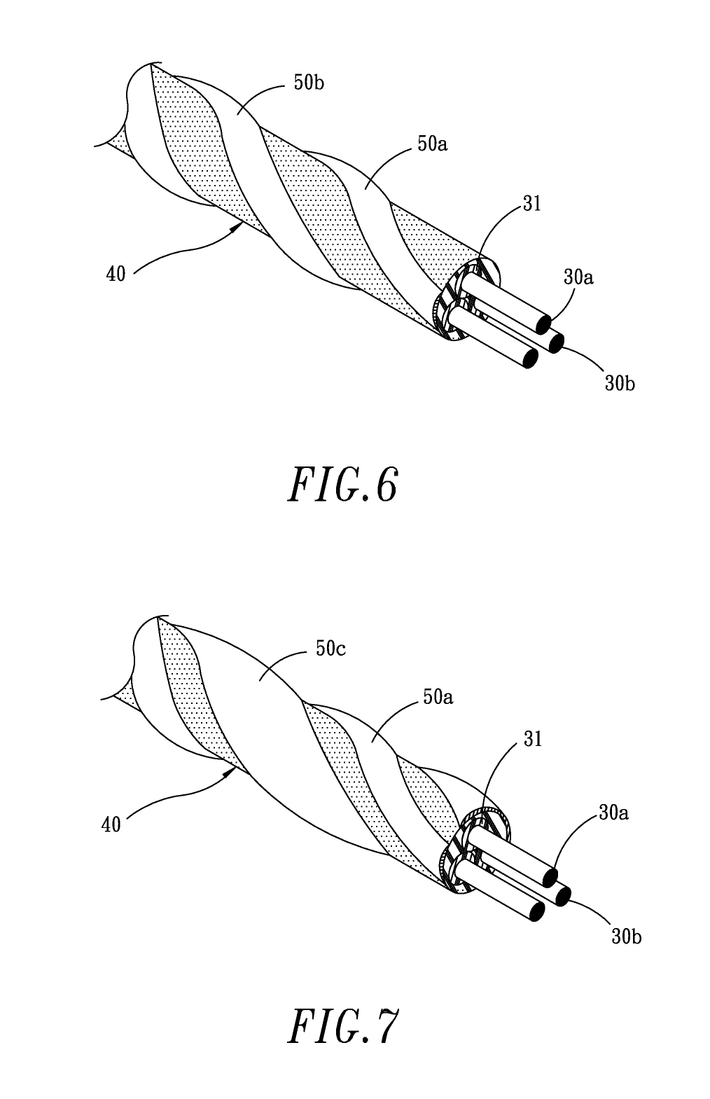

In the structure of an embodiment according to the present invention, the spiral enhancing layer 50a included therein can be of a uni-spiral structure (i.e., comprising only a single spiral enhancing layer 50a, as shown in FIG. 4). Meanwhile, in the structure of another embodiment according to the present invention, the spiral enhancing layer 50a included therein can be of a multi-spiral structure (i.e., comprising multiple spiral enhancing layers 50a, 50b, as shown in FIG. 5).

Furthermore, in the structure of an embodiment according to the present invention, the spiral enhancing layer 50a can be of a multi-spiral structure (including multiple spiral enhancing layers 50a, 50b), and one example for such multiple spiral enhancing layers 50a, 50b may have a uniform thickness (as shown in FIG. 5). On the other hand, another embodiment of the present invention may be also configured with multiple spiral enhancing layers 50a, 50c of different thicknesses (as shown in FIG. 6).

Besides, since the spiral enhancing layers 50a, 50b, 50c protrude from the outer surface of the insulation cladding layer 40, such spiral enhancing layers 50a, 50b, 50c can constitute a non-slip texture to provide the hand-held non-slip function.

In summary, the structure of the AC power line according to the present invention is characterized in that the insulation protective outer lay includes an insulation cladding layer and a spiral enhancing layer. By means of the spiral structure of the spiral enhancing layer, the anti-tension and anti-extension capabilities of the AC power line can be improved. In addition, the colors of the insulation protective layer and the spiral enhancing layer enable significant visual distinction from background thereby facilitating visual differentiation or identification effects.

Although the present invention has been disclosed through the detailed descriptions of the aforementioned embodiments, such illustrations are by no means used to restrict the present invention. Those skilled ones in the art can made appropriate alternations and modifications thereto as demand without departing from the spirit and scope of the present invention. Hence, the scope of the present invention to be protected under patent laws should be delineated in accordance with the claims set forth hereunder in the present specification.

What is claimed is:

1. An alternative current (AC) power line, comprising:
at least two conductive lines having an insulation sheath; and
an insulation protective outer layer wrapping the exteriors of the at least two conductive lines, wherein the insulation protective outer layer includes: an insulation cladding layer and a spiral enhancing layer, in which the spiral enhancing layer is attached to the outer surface of the insulation cladding layer in a spiral way along the axial direction of the AC power line, and, in the traverse cross-section direction of the AC power line, the spiral enhancing layer is jointed in a spiral pattern and protrudes from the outer surface of the insulation cladding layer.

2. The AC power line according to claim 1, wherein the spiral enhancing layer is of a uni-spiral structure having a single spiral enhancing layer.

3. The AC power line according to claim 1, wherein the spiral enhancing layer is of a multi-spiral structure having multiple spiral enhancing layers.

4. The AC power line according to claim 3, wherein the multiple spiral enhancing layers in the multi-spiral structure have a uniform thickness.

5. The AC power line according to claim 3, wherein the multiple spiral enhancing layers in the multi-spiral structure have different thicknesses.

6. The AC power line according to claim 1, wherein the spiral enhancing layer and the insulation cladding layer have different colors.
